(19) United States
(12) Patent Application Publication
(10) Pub. No.: US 2024/0424914 A1
(43) Pub. Date: Dec. 26, 2024

(54) MULTI-UNIT ROAD VEHICLE WITH SEPARATE PER-UNIT DRIVE CONTROL

(71) Applicant: D.S. RAIDER LTD., Kefar-Saba (IL)

(72) Inventor: Erez ABRAMOV, Moshav Hagor (IL)

(21) Appl. No.: 18/691,941

(22) PCT Filed: Sep. 14, 2022
(86) PCT No.: PCT/IL2022/050993

§ 371 Date: Mar. 14, 2024

Related U.S. Application Data
(60) Provisional application No. 63/243,894, filed on Sep. 14, 2021.

(51) Int. Cl. B60L 15/38; B60L 15/20

(52) U.S. Cl. CPC B60L 15/38; B60L 15/20; B60L 2240/14; B60L 2240/461

(57) ABSTRACT

A multi-unit road vehicle including multiple vehicle units, each vehicle unit (VU) of the multi-unit road vehicle may include: a VU body: at least one connecting mechanism for connecting the VUs to one another VU: two or more wheel sets. wherein each wheel set connects to a different side of the VU body: and two or more controllable motors, each motor configured to controllably operate one or more wheels of a specific wheel set of the respective VU. Each motor of each wheel set of each VU may be independently and separately controllable. at least for independent and separate controlling of rotation speed of each of the one or more wheels of each wheel set for separate and independent wheels operation such as wheels rotation speed of each side of the VU.

The present disclosure relates in general to multi-unit vehicles and more particularly to multi-unit road vehicles with separate per-unit drive control.

### BACKGROUND

Multi-unit (MU) vehicles such as trains typically include a main train vehicle and multiple carriages trains connected to one another, where each of the carriages of the MU train is driven by a single main controller, typically located at the train vehicle of the MU train/vehicle.

When towing one or more connected vehicles by a carrier main vehicle, especially when driving over a road (rather than over train rails), it is difficult to steer all the vehicles in a safe manner, especially under rough road and/or other external conditions, depending on weight and length of each of the main and towed vehicles and the overall weight and length of the entire “MU vehicle”.

### SUMMARY

Aspects of disclosed embodiments pertain to a multi-unit road vehicle (MURV) comprising at least:
a set of multiple vehicle units (VUs), wherein each vehicle unit (VU) of the MURV comprises at least:
a VU body;
at least one connecting mechanism for removably connecting each VU to at least one other VU;
two or more wheel sets, wherein each wheel set comprises at least one wheel, and wherein each wheel set connects to a different side of the VU body; and
two or more controllable motors, each motor configured to controllably operate one or more wheels of a specific wheel set of the VU, wherein each motor of each wheel set the VU is independently and separately controllable, in respect to the other wheel set of the VU, for independent and separate controlling of operation of the at least one wheel of the corresponding wheel set of the VU, wherein, since each wheel set is located at a different side of each VU and separately controlled, each side of the VU can be separately and independently driven.

According to some embodiments, the independent and separate controlling of operation of the at least one wheel of the corresponding wheel set of the VU may be done by controlling one or more of: rotation speed of each wheel of each wheel set of the corresponding VU; steering position of each wheel of each wheel set of the corresponding VU.

Other aspects of disclosed embodiments pertain to a method for controlling multiple vehicle units (VUs) of a multi-units road vehicle (MURV), the method comprising at least:
providing a MURV;
determining or receiving, separately for each wheel set of each VU of the MURV, control commands associated with wheel state of each wheel of each wheel set of each VU of the MURV; and
controlling each wheel of each wheel set of each VU of the MURV, according to the determined or received control commands associated therewith.

According to some embodiments, the method may further include receiving updated sensor data from sensors located in one or more of the VUs of the MURV and analyzing received updated sensor data for determining control commands of each wheel set of each VU.

According to some embodiments, the method may further include accumulating sensor data over time for each VU of the MURV, analyzing the accumulated sensor data and adjusting analysis of received updated sensor data, based on results of the analysis of the accumulated sensor data.

### BRIEF DESCRIPTION OF THE FIGURES

The figures illustrate generally, by way of example, but not by way of limitation, various embodiments discussed in the present document.

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. References to previously presented elements are implied without necessarily further citing the drawing or description in which they appear. The figures are listed below.

FIG. 1 shows a multi-unit road vehicle (MURV) with separate per-unit drive control, according to some embodiments;

FIG. 2 is a block diagram showing how a main controller of a main vehicle unit of the multi-unit road vehicle communicates with controllers of each carrier vehicle unit of the MURV, according to some embodiments; and

FIG. 3 is a flowchart schematically illustrating a method for separate controlling of wheels of each wheels set of each vehicle unit (VU) of the MURV.

### DETAILED DESCRIPTION

Aspects of disclosed embodiments pertain to multi-unit road vehicles including multiple vehicle units moveably (and optionally removably) connectable to one another, with a separate per vehicle unit drive control. The multi-unit road vehicle, according to some embodiments, may be designed especially yet not exclusively for optimal vehicle steering and driving of the multiple vehicle units in rugged terrain as well as for easy turning and maneuvering of the multi-unit road vehicle in twisted roads especially when using a long chain and/or large number of connected vehicle units.

According to some embodiments, there is provided a multi-unit road vehicle (MURV) may include at least:
multiple vehicle units (VUs) moveably connectable to one another, including, for example: a main (VU); and (ii) one or more carriage VUs.

For example, each VU may include: a VU body; at least one connecting mechanism for moveably connecting the VU to at least one other VU; two or more wheel sets, wherein each of at least two opposite sides of the VU body connects to a different wheel set; and two or more controllable motors, each motor connecting to a different wheel set of the VU and separately and independently controls the operation of the respective wheel set to which it connects.

Each motor of each wheel set of each VU of the MURV, may be independently and separately controllable, at least for independent and separate controlling of rotation speed of each of the one or more wheels of each wheel set. Since each wheel set is located at a different side of the respective VU, each side of the VU can be separately and independently driven, improving thereby adaptivity of the respective VU and the entire MURV to local road conditions.

According to some embodiments, each motor of each wheel set of each VU may be separately controllable via a main controller, e.g., located at the main VU and/or via a local controller configured to control only the specific motor. The main controller may in any case be configured to communicate with all local controllers and/or motors, for coordinating steering of wheel(s) of each wheel set of each VU, in relation to all other wheel sets of the same and other VUs to optimize responsivity to road conditions (bumps, obstacles, curves and turns, etc.).

According to some embodiments, the main controller may be configured to process, in real time, data, indicative of the road and/or of several or all of the MURV's VUs, using one or more analysis software-algorithms and/or hardware based devices, for determining, for each wheel of each wheel set of each VU of the MURV, its current optimal speed, and adjust the speed of each wheel according to its determined current optimal speed.

In some embodiments, the MURV may also be configured for real time per-VU and per wheel set steer control, e.g. by controlling wheels rotation speed of the wheel set, determining an optional optimal steering position (angular position/orientation) of each wheel of each wheel set and/or controlling elevation level/position of each wheel of each wheel set of the VU (e.g., by controlling length of an extendible element(s) connected to the wheel) for optimal responsivity to road conditions and real time MURV steering requirements.

The determination of the optimal current speed (and optionally optimal current steering position) of each wheel of each VU of the MURV, may be done based on detected road conditions as well as based on information related to the specific MRVU and its VUs (herein “MURV information”). For example, the MURV information may include details related to: the overall number of VUs, the size of each of the VUs, the steering limits and span of each wheel in each wheel set of each VU, motor drive shaft speed limit/motor output power limit, weight and/or weight limit of each VU, the relative location of each VU in respect to the other VUs of the MURV, etc.

In some embodiments, the main VU of the MURV may include a road sensing and estimation device, including one or more sensors for enable sensing one or more VU and/or the entire MURV external and/or internal parameters such as for identifying road topography of the area in which the specific VU of the MURV or the MURV is located based on known information such as topography updated maps coordinated with on automatic identification of the location of the MURV, e.g., based on global positioning system (GPS) detection and devices, etc. Information and/or sensor data, collected in real time, may be processed, in real time, to determine each motor's operation characteristics including optimal output power (associated with optimal wheel rotation speed) and optionally also to determine optimal steering position of each wheel o each wheel set. Once the optimal characteristics have been determined the motors and/or other parts operating each wheel set can be controlled, according to the determined optimal characteristics.

According to some embodiments, the sensors may include one or more of: accelerometer(s) for sensing vibrations and shocks and/or VU orientation, GPS(s), microphone(s), thermometer(s), camera(s), pressure-meter(s), tactile sensor(s) for sensing vibrations and shocks, etc.

According to some embodiments, each VU may be equipped with one or more sensors for autonomous sensing of local road and/or VU state and autonomous motor control of each of its wheel sets.

Optionally, the VU may also be configured to transmit updated sensor data indicative to the main controller of the MURV for further steering and/or motors control adjustment and/or coordination.

According to some embodiments, the MURV may be modular i.e., enabling to adjust and change its number of carriages VUs and their types. The main controller may be further configured to adjust the manner in which optimal characteristics are determined, based on input information indicating the number and type of currently connected VUs. The type of each VU may be associated with the VU properties such as, weight, size, dimensions, wheel sets number and configuration, motor power/speed ranges, and the like.

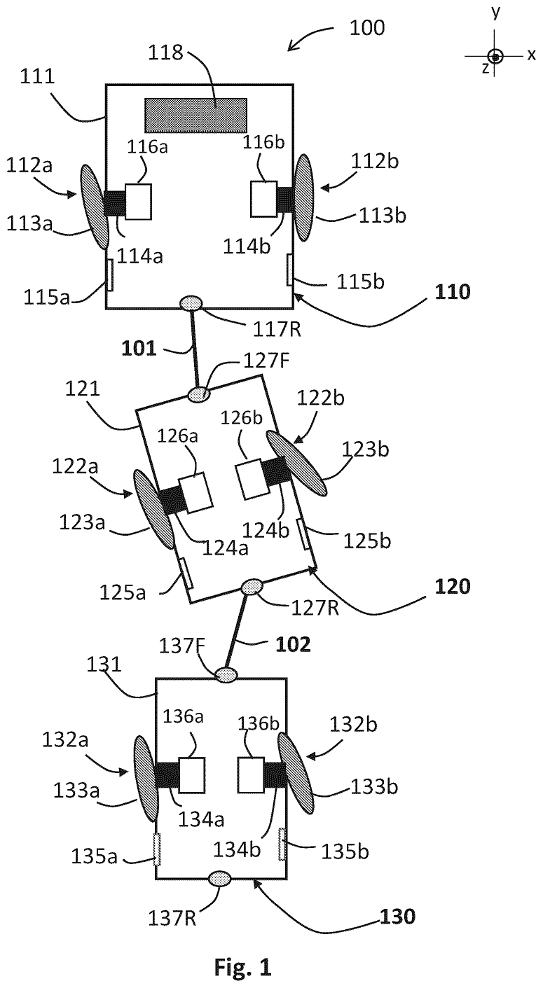

Reference is now made to FIG. 1, illustrating a MURV 100 having three VUs: a main VU 110 and two carriage VUs 120 and 130. In this example, the main VU 110 is different in type and characteristics and the other two VUs 120 and 130 are of the same type and characteristics.

As shown in FIG. 1, the main VU 110 includes:
a main VU body 111;
two wheel sets: 112a and 112b, each wheel set 112a/112b having a single wheel 113a/113b, the wheel sets 112a and 112b being located on opposite sides of the VU body 111 of the main VU 110;
two motors 114a and 114b, where motor 114a is operatively connected to wheel 113a for rotating thereof a rotation axis that is perpendicular to an axis x, and motor 114b is operatively connected to wheel 113b for rotating thereof about a rotation axis that is perpendicular to axis x;
a main controller 118 and/or two local controllers 116a and 116b where local controller 116a is configured, connected and located to control operation of motor 114a and local controller 116b is configured, connected and located to control operation of motor 114b;
one or more connecting apparatuses such as rear connecting apparatus 117R for connecting one side (e.g., rear) of the main VU 110 to another VU 120 in a movable manner, such that the two VUs 110 and 120 are able to move one in respect to the other responsively to the driving control and road conditions at least in a plane (e.g., xy plane).

Similarly, carriage VUs 120 and 130 may each include:
a main VU body 121/131;
two wheel sets: 122a/132a and 122b/132b, each wheel set 122a/122b, 132a/132b having a single wheel 123a/123b, 133a/133b, the wheel sets 122a/132a and 122b/132b being located on opposite sides of the VU body 121/131 of the main VU 120/130;
two motors 124a/134a and 124b/134b, where motor 124a/134a is operatively connected to wheel 123a/133a for rotating thereof a rotation axis that is perpendicular to an axis x, and motor 124b/134b is operatively connected to wheel 123b/123b for rotating thereof about a rotation axis that is perpendicular to axis x;
two local controllers 126a/136a and 126b/136b where local controller 126a/136a is configured, connected and located to control operation of motor 124a/134a and local controller 126b/136b is configured, connected and located to control operation of motor 124b/134b;
one or more connecting apparatuses such as rear connecting apparatus 127R/137R for connecting a rear side of the VU 120/130 to another VU and a front connecting apparatus 127F/137F for connecting a front side of the VU 120/130 to another VU. For example, as shown in FIG. 1, the Front connecting apparatus 127F of VU 120 may moveably connect to the main VU 110 via connector 101 and the Front connecting apparatus 137F of VU 130 may moveably connect to VU 120 via connector 102.

According to some embodiments, each VU may also include at least one separate per-VU power supply unit including for instance one or more batteries for powering the motors of the specific VU. According to embodiments, each wheel set may be separately powered by a different power supply unit of the VU. According to other embodiments all motors of all wheel sets of the same VU may be powered by the same single power supply unit.

According to some embodiments, each VU 110/120/130 or only some or one of them may have one or more sensors, for sensing thereby one or more physical characteristics of the respective VU 110/120/130 such as shaking and movement of the VU, orientation of the VU, bouncing of the VU, etc., and/or for sensing physical characteristics of a proximate environment of the specific VU 110/120/130 such as road conditions, temperature, moisture (precipitation identification), close-by obstructions or objects (including people, endangering holes, bumps or large still object ion the road. etc.) and the like. For example, each of the VUs 110, 120 and 130 may include two sensors: main VU 110 includes sensors 115a and 115b, VU 120 includes sensors 125a and 125b, and VU 130 includes sensors 135a and 135b.

The sensors of each VU 110/120/130 may include any one or more of: proximity sensor, movement sensor, camera, optical sensor, moisture sensor, thermometer, acoustic sensor, etc. for sensing VU and/or VU-proximal environment characteristics.

According to some embodiments, each controller 116a-136b of each motor 114a-134b of each VU 110/120/130 may be configured for receiving sensor data (from sensor(s) of the respective vehicle associated with the respective controller) and processing received sensor data to detect obstacles, road features, temperature, VU malfunctioning etc. and determine drive attributes such as steering parameters and/or wheel speed for each wheel of each wheel set, based on sensor data analysis results, in real time or near real time, in respect to the sensing and processing/analysis timing.

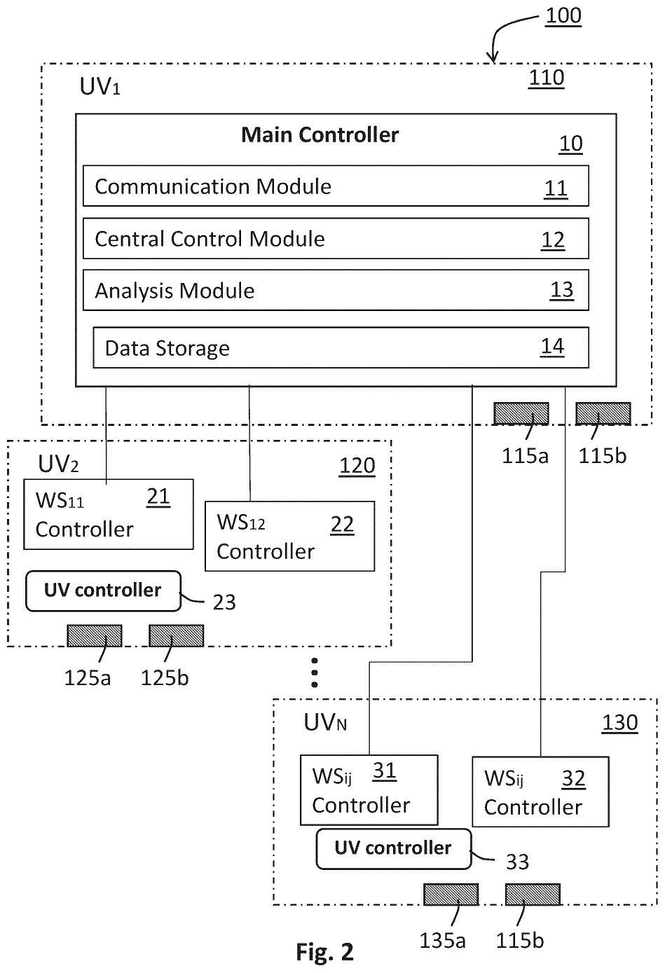

Reference is now made to FIG. 2, which shows a block diagram, schematically illustrating optional modules of the main controller 10 of a main VU (UV1) such as main VU 110 of a MURV such as MURV 100, according to some embodiments, for a MURV 100 that includes an N number of connected VUs such as VU₂ to VU_{N}, each VU having a VU controller 23 for VU2 120 and 33 for VUN 130 and a pair wheel set (WS) controllers 21 and 22 and 31 and 32 one controller pair for each wheel set that controls the wheels of the respective VU 120/130. Each wheel set includes at least one wheel located on one side of the respective VU 120/130 and at least one motor controlling at least wheel spinning speed of each wheel of the respective wheel set. Where each pair of wheel sets of each VU 120/130 are located at opposite side of the respective VU 120/130 in respect to one another.

Accordion to some embodiments, the main controller 10 may include:
(i) a communication module 11 for communicating at least with the WS controllers 21-32 (and optionally sensors) of all N connected to the main VU: VU1110, for controlling at least wheel speed of each wheel of each wheel set WS₁₁-WSᵢⱼ of each VU of the MURV, the communication module 11 may be further configured for communication with one or more remote system(s)/device(s), hub(s), etc.;
(ii) a central control module 12, configured for central controlling of all VUs VU₁-VU_{N} of the MURV, the central control module 12 may be further configured to receive and analyze updated sensors data and accumulate sensor data and/or analysis results over time;
(iii) an analysis module 13 configured to operate data analysis module(s)/algorithm(s) such as analysis of updated sensor data, directly or indirectly arriving from the sensors of the VUs such as sensors 115a, 115b, 125a, 125b, 135a and 135b, and optionally also operate learning and/or adjustment models/algorithms programmed for machine learning, artificial intelligence (AI) and/or other accumulated data ongoing analysis for improving MURV data analysis techniques and/or to improve VUs control;
(iv) data storage 14 for storing for example, accumulated sensor data, accumulated data analysis results etc.

According to some embodiments, each towed VU such as VU2 120 and VUN 130, may also include a VU controller such as VU controllers 23 and 33, e.g., serving as a relay point between the main controller 10 and the VUs 120/130 for example by receiving sensors data from the local sensors of each VU and transmitting it to the main controller 10 and/or by receiving wheels control commands or control signals and transmitting them per wheel to the controller that control each wheel of each wheel set of the respective VU.

It is to be noted that the term data may refer to any information and/or signals that are indicative of any condition of the VU or an environment thereof detected in real time e.g., via sensing, or any other means (such as receiving power consumption data/signals from each motor of each VU.

It is to be noted as mentioned above, that each side, out of two opposite sides, of each VU is separately and individually controllable such that at each moment in time, at least rotation speed of wheel(s) of one side of the VU can differ from rotation speed of wheel(s) of the opposite side of the same VU, for improved steering and responsivity of the row of VUs of each MURV to road conditions, MURV limitations such as number of VUs connected, sizes and weight thereof etc., and type of connectivity between each two connected VUs.

For example, the connection between each two adjacent VUs allows rotational movement of the connector connecting them about a rotation axis such z axis as shown in FIG. 1 allowing each connector 101/102 to move within a plane parallel to the xy plane that is perpendicular to the z axis. Slight up and down movement parallel to the z axis of each VU 110/120/130 may also be enabled by using suspension springs vertically connecting each wheel with the VU body 111/121/131. This combination may enable optimal steering and driving of a long line of VUs connected in a movable manner into a single MURV, through challenging road conditions.

According to some embodiments, each VU may be electronically connected and/or communicative with one or more other VUs in an independent/separate manner in addition or instead of being connected and/or communicative with a main VU—such as, for example, to enable each VU become a leading VU (train) without necessarily requiring a main controller.

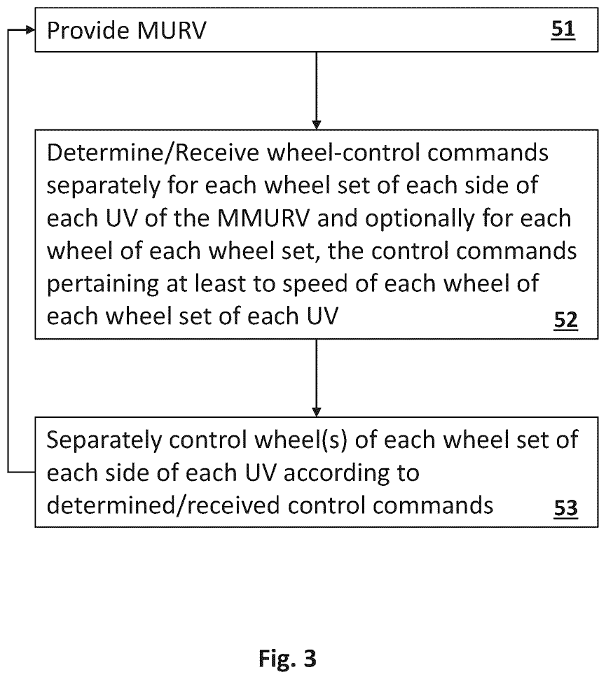

Reference is now made to FIG. 3, which is a flowchart that schematically illustrates a method for separate controlling of wheels of each wheels set of each vehicle unit (VU) of a multi-units road vehicle (MURV). The method may include at least:
providing a MURV 51 such as MURV 100;
determining and/or receiving control commands separately for each wheel set of each VU 52 of the MURV e.g., by analyzing updated sensor data arriving from the sensor(s) of each VU or by receiving direct input from the driver associated with controlling of each wheel of each wheel set of each VU and optionally for each wheel in each such wheel set, where the control commands may be associated with wheel(s) speed and/or wheel(s) steering state of each wheel; and
controlling each wheel of each wheel set of each VU of the MURV, according to the determined/received control commands.

According to some embodiments, the control commands may be determined/received at the main controller of the main VU and transmitted (wirelessly or via communication cables) to each local VU controller of each VU of the MURV.

### EXAMPLES

Example 1 is a multi-unit road vehicle (MURV) comprising at least:
a set of multiple vehicle units (VUs), wherein each vehicle unit (VU) of the MURV comprises at least:
a VU body;
at least one connecting mechanism for removably connecting each VU to at least one other VU;
two or more wheel sets, wherein each wheel set comprises at least one wheel, and wherein each wheel set connects to a different side of the VU body; and
two or more controllable motors, each motor configured to controllably operate one or more wheels of a specific wheel set of the VU, wherein each motor of each wheel set the VU is independently and separately controllable, in respect to the other wheel set of the VU, for independent and separate controlling of operation of the at least one wheel of the corresponding wheel set of the VU, wherein, since each wheel set is located at a different side of each VU and separately controlled, each side of the VU can be separately and independently driven.

In example 2, the subject matter of example 1 may include, wherein the independent and separate controlling of operation of the at least one wheel of the corresponding wheel set of the VU comprises controlling one or more of: rotation speed of each wheel of each wheel set of the corresponding VU; steering position of each wheel of each wheel set of the corresponding VU; elevation level of each wheel of each wheel set of the corresponding VU.

In example 3, the subject matter of any one or more of examples 1 to 2 may include, wherein the set of multiple VUs comprises at least one main vehicle and one or more carriage VUs, removably connectable in a chained sequence to one another.

In example 4, the subject matter of any one or more of examples 1 to 3 may include, wherein the main VU comprises a main controller configured to directly or indirectly and separately control motor operation of each wheel set of each VU, for separate control of one or more wheels of each wheel set of each VU of the MURV.

In example 5, the subject matter of example 4 may include, wherein each of one or more of the VUs of the MURV further comprises a local VU controller that is configured to directly or indirectly transmit control commands or control signals from the main controller to the two or more motors of the corresponding VU.

In example 6, the subject matter of any one or more of examples 4 to 5 may include, wherein one or more of the VUs of the MURV further comprises one or more sensors for sensing one or more external and/or internal parameters of the specific VU to which they are attached and/or of the entire MURV.

In example 7, the subject matter of example 6 may include, wherein the one or more sensors comprise one or more of: accelerometer, camera, GPS, pressure sensor, thermometer, microphone.

In example 8, the subject matter of any one or more of examples 4 to 7 may include, wherein the main controller is configured to receive and analyze updated sensor data from the sensors, in real time or near real time, to determine one or more control parameters for controlling each wheel of each wheel set of each VU of the MURV, wherein the control parameters comprise one or more of: wheel speed, steering position, wheel elevation position.

In example 9, the subject matter of any one or more of examples 1 to 8 may include, wherein each wheel set of each VU further comprises a separate per-wheel-set, wheel-set controller, for direct per wheel set control.

In example 10, the subject matter of any one or more of examples 1 to 9 may include, wherein each VU further comprises at least one power supply unit for supplying power to the motors of the wheel sets of the corresponding VU.

In example 11, the subject matter of example 10 may include, wherein each wheel set of each VU is powered by a different power supply unit of the corresponding VU.

In example 12, the subject matter of 4 may include, wherein the main controller comprises one or more of:
(i) a communication module for communicating at least with VU controllers, which separately control each wheel set of each VU;
(ii) a central control module, configured for central controlling of all VUs of the MURV;
(iii) an analysis module configured to operate one or more data analysis modules and/or algorithms for determining control command for each wheel set of each VU of the MURV for controlling motor operation thereof;
(iv) data storage for storing control commands, accumulated sensor data and/or accumulated data analysis results.

Example 13 is a method for controlling multiple vehicle units (VUs) of a multi-units road vehicle (MURV), the method comprising at least:
providing a MURV according to any one or more of the MURVs described in relation to examples 1 to 12;
determining or receiving, separately for each wheel set of each VU of the MURV, control commands associated with wheel state of each wheel of each wheel set of each VU of the MURV; and
controlling each wheel of each wheel set of each VU of the MURV, according to the determined or received control commands associated therewith.

In example 14, the subject matter of example 13 may include, wherein the method further comprises receiving updated sensor data from sensors located in one or more of the VUs of the MURV and analyzing received updated sensor data for determining control commands of each wheel set of each VU.

In example 15, the subject matter of example 14 may include, further comprising accumulating sensor data over time for each VU of the MURV, analyzing the accumulated sensor data and adjusting analysis of received updated sensor data, based on results of the analysis of the accumulated sensor data.

Although the above description discloses a limited number of exemplary embodiments of the invention, these embodiments should not apply any limitation to the scope of the invention, but rather be considered as exemplifications of some of the manners in which the invention can be implemented.

The method and/or processes described herein may be implemented by any one or more software, and/or hardware, element apparatus, device, mechanism, electronic and/or digital computerized system, unit, processing module, device, machine, engine, etc.

The system, module, unit, device etc. or parts thereof, may be programmed to perform particular functions pursuant to computer readable and executable instructions, rules, conditions etc. from programmable hardware and/or software based execution modules that may implement one or more methods or processes disclosed herein, and therefore can, in effect, be considered as disclosing a “special purpose computer” particular to embodiments of each disclosed method/process.

Additionally or alternatively, the methods and/or processes disclosed herein may be implemented as a computer program that may be tangibly or intangibly embodied by a special purpose computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” may also include distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

A module, a device, a mechanism, a unit and or a subsystem may each comprise a machine or machines executable instructions (e.g. commands). A module may be embodied by a circuit or a controller programmed to cause the system to implement the method, process and/or operation as disclosed herein. For example, a module may be implemented as a hardware circuit comprising, e.g., custom very large-scale integration (VLSI) circuits or gate arrays, an Application-specific integrated circuit (ASIC), off-the-shelf semiconductors such as logic chips, transistors, and/or other discrete components. A module may also be implemented in programmable hardware devices such as field programmable gate arrays, programmable array logic, programmable logic devices and/or the like.

In the above disclosure, unless otherwise stated, terms such as “substantially”, “about”, approximately, etc., that specify a condition or relationship characterizing a feature or features of an embodiment of the invention, are to be understood to mean that the condition or characteristic is defined to within tolerances that are acceptable for operation of the embodiment for an application for which it is intended.

It is important to note that the methods/processes and/or systems/devices/subsystems/apparatuses etc., disclosed in the above Specification, are not to be limited strictly to flowcharts and/or diagrams provided in the Drawings. For example, a method may include additional or fewer processes or steps in comparison to what is described in the figures. In addition, embodiments of the method are not necessarily limited to the chronological order as illustrated and described herein.

It is noted that terms such as “processing”, “computing”, “calculating”, “determining”, “establishing”, “analyzing”, “checking”, “estimating”, “deriving”, “selecting”, “inferring”, “identifying ”, “detecting” and/or the like, may refer to operation(s) and/or process(es) of a computer, a computing platform, a computing system, or other electronic computing device(s), that manipulate and/or transform data represented as physical (e.g., electronic or optical signal) quantities within the computer's registers and/or memories into other data similarly represented as physical quantities within the computer's registers and/or memories or other information storage medium that may store instructions to perform operations and/or processes.

Terms used in the singular shall also include a plural scope, except where expressly otherwise stated or where the context otherwise requires.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made i.e. enabling all possible combinations of one or more of the specified options. Further, the use of the expression “and/or” may be used interchangeably with the expressions “at least one of the following”, “any one of the following” or “one or more of the following”, followed by a listing of the various options.

It is appreciated that certain features of the invention, which are, for clarity, described in the context of separate embodiments or example, may also be provided in combination in a single embodiment and/or other known in the art or unknown in the art objects/parts/devices/systems/subsystems that are not mentioned or briefly described.

Additionally or alternatively, various features of the invention, which are, for brevity, described in the context of a single embodiment, example and/or option, may also be provided separately or in any suitable sub-combination or as suitable in any other described embodiment, example or option of the invention. Certain features described in the context of various embodiments, examples and/or optional implementation are not to be considered essential features of those embodiments, unless the embodiment, example and/or optional implementation is inoperative without those elements.

The number of elements shown in the Figures should by no means be construed as limiting and is for illustrative purposes only.

1. A multi-unit road vehicle (MURV) comprising at least:
a set of multiple vehicle units (VUs), wherein each vehicle unit (VU) of the MURV comprises at least:
a VU body;
at least one connecting mechanism for removably connecting each VU to at least one other VU;
two or more wheel sets, wherein each wheel set comprises at least one wheel, and wherein each wheel set connects to a different side of the VU body; and
two or more controllable motors, each motor configured to controllably operate one or more wheels of a specific wheel set of the VU, wherein each motor of each wheel set the VU is independently and separately controllable, in respect to the other wheel set of the VU, for independent and separate controlling of operation of the at least one wheel of the corresponding wheel set of the VU,
wherein, since each wheel set is located at a different side of each VU and separately controlled, each side of the VU can be separately and independently driven.

2. The MURV of claim 1, wherein the independent and separate controlling of operation of the at least one wheel of the corresponding wheel set of the VU comprises controlling one or more of:
rotation speed of each wheel of each wheel set of the corresponding VU;
steering position of each wheel of each wheel set of the corresponding VU;
elevation level of each wheel of each wheel set of the corresponding VU.

3. The MURV of claim 1, wherein the set of multiple VUs comprises at least one main vehicle and one or more carriage VUs, removably connectable in a chained sequence to one another.

4. The MURV of claim 1, wherein the main VU comprises a main controller configured to directly or indirectly and separately control motor operation of each wheel set of each VU, for separate control of one or more wheels of each wheel set of each VU of the MURV.

5. The MURV of claim 4, wherein each of one or more of the VUs of the MURV further comprises a local VU controller that is configured to directly or indirectly transmit control commands or control signals from the main controller to the two or more motors of the corresponding VU.

6. The MURV of claim 4, wherein one or more of the VUs of the MURV further comprises one or more sensors for sensing one or more external and/or internal parameters of the specific VU to which they are attached and/or of the entire MURV.

7. The MURV of claim 6, wherein the one or more sensors comprise one or more of: accelerometer, camera, GPS, pressure sensor, thermometer, microphone.

8. The MURV of claim 4, wherein the main controller is configured to receive and analyze updated sensor data from the sensors, in real time or near real time, to determine one or more control parameters for controlling each wheel of each wheel set of each VU of the MURV, wherein the control parameters comprise one or more of: wheel speed, steering position, wheel elevation position.

9. The MURV of claim 1, wherein each wheel set of each VU further comprises a separate per-wheel-set, wheel-set controller, for direct per wheel set control.

10. The MURV of claim 1, wherein each VU further comprises at least one power supply unit for supplying power to the motors of the wheel sets of the corresponding VU.

11. The MURV of claim 10, wherein each wheel set of each VU is powered by a different power supply unit of the corresponding VU.

12. The MURV of claim 4, wherein the main controller comprises one or more of:
(i) a communication module for communicating at least with VU controllers, which separately control each wheel set of each VU;
(ii) a central control module, configured for central controlling of all VUs of the MURV;
(iii) an analysis module configured to operate one or more data analysis modules and/or algorithms for determining control command for each wheel set of each VU of the MURV for controlling motor operation thereof;
(iv) data storage for storing control commands, accumulated sensor data and/or accumulated data analysis results.

13. A method for controlling multiple vehicle units (VUs) of a multi-units road vehicle (MURV), the method comprising at least:
providing a MURV according to claim 1;
determining or receiving, separately for each wheel set of each VU of the MURV, control commands associated with wheel state of each wheel of each wheel set of each VU of the MURV; and
controlling each wheel of each wheel set of each VU of the MURV, according to the determined or received control commands associated therewith.

14. The method of claim 13 further comprising receiving updated sensor data from sensors located in one or more of the VUs of the MURV and analyzing received updated sensor data for determining control commands of each wheel set of each VU.

15. The method of claim 14, further comprising accumulating sensor data over time for each VU of the MURV, analyzing the accumulated sensor data and adjusting analysis of received updated sensor data, based on results of the analysis of the accumulated sensor data.

16. A main controller for a multi-unit road vehicle (MURV) comprising a set of multiple vehicle units (VUs), wherein each VU comprises at least two wheel sets each wheel set of each VU being located opposite to the other wheel set of the VU,
wherein each wheel set comprises at least one wheel, and at least one controllable motor, a VU body;
at least one connecting mechanism for removably connecting each VU to at least one other VU;
two or more wheel sets, wherein each wheel set comprises at least one wheel, and wherein each wheel set connects to a different side of the VU body; and
two or more controllable motors, each motor configured to controllably operate one or more wheels of a specific wheel set of the VU, wherein each motor of each wheel set the VU is independently and separately controllable, in respect to the other wheel set of the VU, for independent and separate controlling of operation of the at least one wheel of the corresponding wheel set of the VU,
wherein, since each wheel set is located at a different side of each VU and separately controlled, each side of the VU can be separately and independently driven.
